(19) United States
(12) Patent Application Publication
(10) Pub. No.: US 2019/0220908 A1
(43) Pub. Date: Jul. 18, 2019

(54) CHARITABLE GIVING MATCHING VIA ROUNDUP

(71) Applicant: Galileo Processing, Inc., Salt Lake City, UT (US)

(72) Inventor: T. Clay Wilkes, North Salt Lake, UT (US)

(21) Appl. No.: 16/250,981

(22) Filed: Jan. 17, 2019

Related U.S. Application Data
(60) Provisional application No. 62/618,530, filed on Jan. 17, 2018.

(51) Int. Cl. G06Q 30/02; G06Q 20/12

(52) U.S. Cl. CPC G06Q 30/0279; G06Q 20/12

(57) ABSTRACT

A method may include receiving consumer donor information about a consumer donor including a trigger purchase, a donation roundup amount, a selectable charity cause for receiving at least a portion of the donation roundup amount, and a selectable contribution weight of the donation roundup amount corresponding to the charity cause. The method may further include receiving approved charitable entity information including at least one associated charity cause and at least one priority requiring monetary funds for advancement; and determining a matching donor entity and a donee entity based on one or more of the received consumer donor information, the received matching entity information, and the received approved charitable entity information. In response to the determining, the method may include generating combined contribution data. Based on the generated combined contribution data, the method may include identifying and sending a total monetary value to the donee entity.

### FIELD

The application relates generally to charitable giving matching via roundup.

### BACKGROUND

Charities and non-profit organizations have often sought donations from donors to further a charitable cause that the charity or non-profit organization is supporting. Donors may provide such donations upon request or voluntary initiative. To further the charitable cause even more, persons or entities may choose to match the donations from others towards the charitable cause.

The subject matter claimed in this disclosure is not limited to embodiments that solve any disadvantages or that operate only in environments such as those described above. Rather, this background is only provided to illustrate one example technology area where some embodiments described in this disclosure may be practiced.

### SUMMARY

Aspects of the present disclosure may include systems and methods with steps and/or operations performed that include receiving consumer donor information about a consumer donor. The consumer donor information may include a trigger purchase, a donation roundup amount, a selectable charity cause for receiving at least a portion of the donation roundup amount, and a selectable contribution weight of the donation roundup amount corresponding to the charity cause. The steps and/or operations may further include receiving matching entity information that may include a pledge amount and at least one associated charity cause.

Additionally, the steps and/or operations may include: receiving approved charitable entity information including at least one associated charity cause and at least one priority requiring monetary funds for advancement; and determining a matching donor entity and a donee entity based on one or more of the received consumer donor information, the received matching entity information, and the received approved charitable entity information. In response to the determining, the steps and/or operations may include generating combined contribution data including: a consumer donor identification label; a matching donor entity identification label; a donee entity identification label; a monetary amount label including a separate amount for both of the donation round-up amount from the consumer donor and a matched amount from the matching donor entity; an associated charity cause label; and a trigger purchase label identifying the trigger purchase.

Additionally, the steps and/or operations may include: based on the generated combined contribution data, identifying a total monetary value to send to the donee entity; based on the generated combined contribution data, generating a statement with one or more labels itemized; and providing the generated statement to the consumer donor.

The objects and advantages of the embodiments will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates a flow diagram of an example method to perform a purchase roundup matched donation; and

FIG. 2 illustrates a block diagram of an example computing system communicatively coupled to an example database to perform a purchase roundup matched donation.

### DESCRIPTION OF EMBODIMENTS

Some embodiments described in this disclosure may include a system and method that are configured to provide a way for consumers (e.g., donors) to perform a charitable act using purchase roundups by donating a monetary sum to a charity organization in the amount of X cents (¢) to make a purchase an even dollar ($) amount. For example, an initial purchase amount of $30.25 at a grocery store may result in a $31.00 purchase total with $0.75 of the total being a charitable roundup donation. In some embodiments, the donor may choose various causes or charitable categories about which the donor cares or desires to advance, such as poverty, education, or the environment. Additionally or alternatively, the consumer donor may weight donations to be received among multiple causes or charitable categories, for example, 30% to poverty, 20% to education, and 50% to the environment. Within these example charity categories, certain charitable organizations may be approved as donees of the roundup donation. Further, in some embodiments, matching entities may pledge to match the roundup donations of the consuming public donors, e.g. dollar for dollar (100%), 50%, or some other percentage up to a predetermined amount.

Based on information pertaining to the consumer donor, the matching entities, and the approved charity organizations, a computing system may be enabled to determine a matching donor entity and a donee. For example, consumer Jane Doe may have selected “HEALTHCARE” as the charity cause she wishes to further advance; the V Foundation for Cancer Research founded by ESPN® and legendary basketball coach Jim Valvano may be an approved charity organization with a specified need of $1 million dollars to fund a particular cancer growth analytics machine, which has not yet been fulfilled; and Coca-Cola®, one of the matching entities, has provided a pledge amount of $300 thousand dollars at a matching rate of 100% to any approved charity organization associated to healthcare causes, where the pledge amount has not yet been depleted. Thus, a clothing purchase by Jane Doe in the amount of $9.70 at a local Wal-Mart® may, as determined by the computing system in view of the foregoing information, result in a roundup donation in the amount of $0.30 from Jane Doe, with Coca-Cola® selected to also donate $0.30, making a sum donation of $0.60 to the V Foundation for Cancer Research to fund the cancer growth analytics machine.

Accordingly, aspects of the present disclosure may include transforming a transaction to include an additional charge in the amount of a donation to a donee, such as a charitable entity. With the transaction transformed, analysis of the transformed transaction may determine an acceptable matching donor and an acceptable donee such that the donation from the donor and a matched donation from the matching donor may both be acceptably donated to and acceptably received by the donee. No conventional method or system has previously facilitated a donation between multiple entities (e.g., a donor, a matching donor, and a donee) each having independent donation policies, requirements, standards, regulations, rules, laws, preferences, beliefs, morals, etc. dictating what may or may not be an acceptable with regards to a donation. Additionally, no mental process or idea in the abstract could facilitate an example practical application of the present disclosure for facilitating an actual donation to a donee that is acceptable to multiple entities involved in the actual donation. The example practical application is also far removed from any mental process or idea in the abstract when performed, for example, in response to a transaction, e.g., at a point of sale such as in a grocery store.

In some embodiments, in response to determining the matching donor entity and the donee as described above, the computing system may determine a combined contribution from the consumer donor and the matching donor entity to a particular donee. In some embodiments, the computing system may be configured to generate combined contribution data with respect to the determined combined contribution with various labels providing different types of information regarding the combined contribution. The combined contribution data generation may help facilitate the computing system's ability to manage the combined contributions. For example, the various labels may identify the consumer donor, identify the matching donor entity, identify the donee entity, provide a monetary amount corresponding to the consumer donor and the matching donor entity, respectively, provide an associated charity cause, and identify a trigger purchase corresponding to the roundup donation by the consumer donor. The labels may then be used by the computing system to generate reports (e.g., statements), make payments, and track fund allocation.

For example, based on the various labels, the computing system may determine a total monetary amount for sending to the donee entity, and a statement may be generated with one or more labels itemized for review. For example, the generated statement may be provided to the consumer donor and/or the matching donor entity for personal records or other analysis. Thus, Jane Doe may receive a monthly statement indicating all the various charity organizations she helped advance by donating roundup donations, including the example provided above with an example itemization such as: January 2018 report for Jane Doe; trigger purchase initiated at Wal-Mart® on 127 Oak Drive at 7:00 pm in the amount of $9.70; Jane Doe has a 100% consumer donor weight for healthcare charity causes (e.g., all donations go to healthcare charities); $0.30 donated from Jane Doe to the V Foundation for Cancer Research; $0.30 donated from Coca-Cola® to the V Foundation for Cancer Research; Coca-Cola® has a 100% matching rate for all healthcare causes up to $300 thousand dollars; the $0.60 total donation to the V Foundation for Cancer Research went towards the cancer growth analytics machine having a $1 million dollar build price.

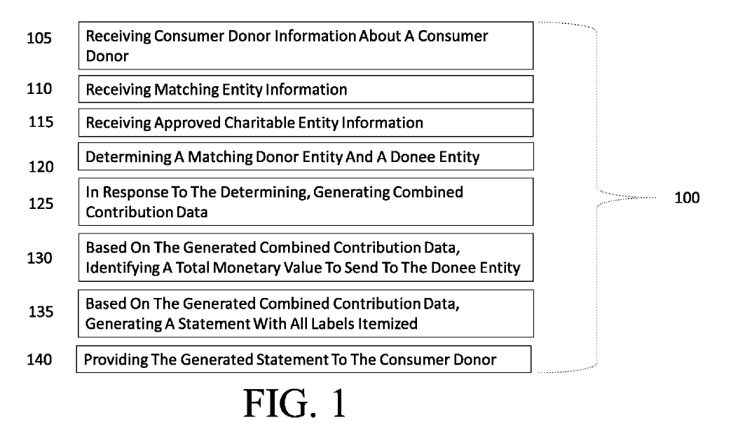

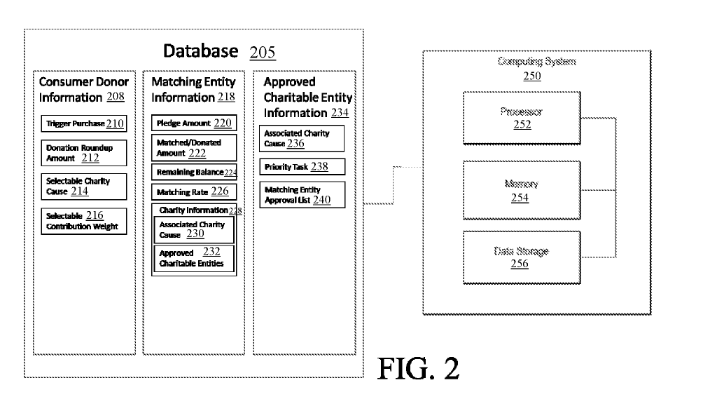

Turning to the figures, FIG. 1 illustrates a flow diagram of an example method 100 to perform a purchase roundup matched donation. The method 100 may be arranged in accordance with at least one embodiment described in the present disclosure. The method 100 may be performed, in whole or in part, in some embodiments by a computing system 250 of FIG. 2, including a processor 252, memory 254, and/or data storage 256, all of which may be coupled to a database 205. For example, in these and other embodiments, some or all of the steps of the method 100 may be performed based on the execution of instructions stored on one or more non-transitory computer-readable media of the memory 254.

Generally, the processor 252 in the computing system 250 may include any suitable special-purpose or general-purpose computer, computing entity, or processing device including various computer hardware or software modules and may be configured to execute instructions stored on any applicable computer-readable storage media. For example, the processor 252 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data.

It is understood that the processor 252 may include any number of processors distributed across any number of networks or physical locations that are configured to perform individually or collectively any number of operations described herein. In some embodiments, the processor 252 may interpret and/or execute program instructions and/or processing data stored in the memory 254. By interpreting and/or executing program instructions and/or process data stored in the memory 254, the computing system 250 may perform operations, such as the operations of FIG. 1.

The memory 254 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor. By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. In these and other embodiments, the term “non-transitory” as used herein should be construed to exclude only those types of transitory media that were found to fall outside the scope of patentable subject matter in the Federal Circuit decision of In re Nuijten, 500 F.3d 1346 (Fed. Cir. 2007). In some embodiments, computer-executable instructions may include, for example, instructions and data configured to cause the processor to perform a certain operation or group of operations as described in the present disclosure.

Although illustrated as discrete blocks, various blocks in FIG. 1 may be divided into additional blocks, combined into fewer blocks, or eliminated, depending on the desired implementation.

The method 100 may begin at block 105, where consumer donor information about a consumer donor may be obtained, for example, from a database. In some embodiments, the consumer donor information may include a trigger purchase, a donation roundup amount, a selectable charity cause for receiving at least a portion of the donation roundup amount, and a selectable contribution weight of the donation roundup amount corresponding to the charity cause. In these or other embodiments, the consumer donor information may be provided to the database in response to user inputs of the consumer donor, a banking representative for the consumer donor, or some other individual authorized to provide the consumer donor information. Additionally or alternatively, the consumer donor information, if publicly available, may be automatically extracted via the computing system. As an example, the computing system may extract social media data from the consumer donor to auto-generate the consumer donor information based on the extracted social media data.

In some embodiments, the trigger purchase may relate to information about a given transaction such as when and where the transaction occurred, the amount of the transaction, the name of the market vendor (e.g., the store or company from which the goods were purchased), and/or a description of the goods associated with the transaction. In some embodiments, the donation roundup amount may be determined by calculating the difference between the amount of the transaction and the next whole dollar amount (e.g., $12.00 [next whole dollar]−$11.28 [transaction amount]=$0.72 [donation roundup]. In these or other embodiments, the selectable charity cause, which may be part of the consumer donor information, may be selected by the consumer donor. For example, the charity cause may be preferential and may include from one to ten selected charity causes (e.g., charity categories such as healthcare, poverty, education, the environment, etc.) about which the consumer donor cares or otherwise wishes to further advance. The charity causes may be expressly chosen by the consumer donor, while in other embodiments, algorithmically learned through survey questions, shopping trends, or social network postings.

Additionally or alternatively, the consumer donor may weigh, via a selectable weight provided by the computing system, the roundup amount corresponding to one or more charity causes. In these or other embodiments, the selectable weight may also correspond to a total donated amount, which equals the roundup amount plus a matched amount from a matching entity. The contribution weights may correspond to an order of preference or degree of importance from the perspective of the consumer donor. For example, poverty may receive an 80% contribution weight while the environment may receive a 20% contribution weight, where an individual places heavy importance, for example, on socioeconomic development in low-income, inner-city neighborhoods or greater opportunities for those in homeless shelters. In this example, 80% of the roundup amount or the total donated amount may go towards the poverty cause. Similar to the charity causes, the contribution weights may be expressly chosen by the consumer donor, while in other embodiments, algorithmically learned through survey questions, shopping trends, or social network postings.

In block 110, matching entity information may be obtained, for example, at the computing system, including a pledge amount and at least one associated charity cause. For example, a matching entity may pledge X amount of dollars for every Y amount of dollars donated by the consumer donor, up to a Z pledge cap. The matching entity may give one or more different pledges for different charity causes, for example, $1 million to the environment and $400 thousand to poverty. In other embodiments, the matching entity may provide only a single pledge associated with a single charity cause. In some embodiments, the matching entity may also include a headquarters address, public record information, shareholders, stakeholders, corporation status, etc. In these or other embodiments, the matching information may be provided to the database in response to user inputs of the matching entity, a banking representative for the matching entity, or some other individual authorized to provide the matching entity information. Additionally or alternatively, the matching entity information, if publicly available, may be automatically extracted via the computing system. As an example, the computing system may extract social media data from the matching entity to auto-generate the matching entity information based on the extracted social media data.

In block 115, charitable entity information may be obtained, for example, by the computing system. The charitable entity may become approved through an application process, a voting process among one or more matching entities, by maintaining certain standards (e.g., quality, diversity, government-mandated qualifications) or having a certain corporation status (e.g., non-profit). In some embodiments, the charitable entity information may also include a headquarters address, public record information, shareholders, stakeholders, corporation status, etc. In these or other embodiments, approved charitable entities may be associated with one or more charitable causes. Additionally or alternatively, each of the approved charitable entities may include a priority detailing at least one task which requires monetary funds in order to advance the task, (e.g., funding the building of a new school). The priority may be visible to one or both of the matching entity and the consumer donor, and in some embodiments, may be part of the process for becoming an “approved” charitable entity. In these or other embodiments, the charitable entity information may be provided to the database in response to user inputs of the charitable entity, a banking representative for the charitable entity, or some other individual authorized to provide the charitable entity information. Additionally or alternatively, the charitable entity information, if publicly available, may be automatically extracted via the computing system. As an example, the computing system may extract social media data from the charitable entity to auto-generate the charitable entity information based on the extracted social media data.

In block 120, a matching donor entity and a donee entity may be determined based on one or more of the received consumer donor information, the received matching entity information, and the received approved charitable entity information. Specifically, the foregoing received information may enable the computing system to determine a matching donor entity and a donee entity. For example, in response to a matching entity having sufficient funds to match the roundup donation of the consumer donor, and in response to the matching entity having the pledged funds directed to a given charitable cause previously selected by the consumer donor, the computing system may select the matching entity as the matching donor entity.

In some embodiments, the matching donor entity may be the market vendor from which the goods are purchased, so long as the market vendor has sufficient pledged funds for a cause selected by the consumer donor. In these or other embodiments, the market vendor may participate in marketing techniques and advertising such as increased matching percentages to incentivize shopping through the vendor and/or to increase awareness of certain charitable causes as a focus of the market vendor. For example, Apple® as a matching entity may incentivize the purchase of their laptops while also advertising the company platform focus on diversity in the techspace workforce by pledging X amount of dollars from every laptop purchase towards education, specifically engaging more women in science, technology, engineering, and math (STEM). In other embodiments, the market vendor may not participate as a matching entity, but a purchase therefrom may still be a triggering purchase as described in other blocks, like block 105.

In block 125, in response to determining the matching donor entity and the donee entity, the computing system may be further enabled to generate combined contribution data. For example, the combined contribution data may include a consumer donor identification label, a matching donor entity identification label, a donee entity identification label, a monetary amount label including a separate amount for both of the donation round-up amount from the consumer donor and a matched amount from the matching donor entity, an associated charity cause label, and a trigger purchase label identifying the trigger purchase. In some embodiments, various labels may be coded for reference purposes and/or for privacy purposes.

In block 130, based on the generated combined contribution data, the computing system may be further enabled to determine a total monetary value to send to the donee entity. For example, based on the monetary amount label, a sum value may be attained (e.g., by adding both of the donation roundup amount to the matched amount). In some embodiments, the computing system may then cause the dispersal of the total donation amount. In some embodiments, the computing system may cause the dispersal of a single lump sum (e.g., the total donation amount) to be dispersed to the approved charitable entity. In other embodiments, the computing system may cause the dispersal of multiple portions of the total donation to the approved charitable entity. The multiple portions of the total donation may be caused to be dispersed simultaneously or at different times. For example, in the event that multiple portions of the total donation come from different banking institutions, the dispersal of the multiple portions may occur at different times. Additionally or alternatively, the donation roundup amount from the consumer donor may occur at a first instance, and the matched/donated amount from the matching entity may occur at a second instance different from the first instance.

In these or other embodiments, when the computing system causes the dispersal of funds, the computing system may send a request to a particular source to transfer funds to the approved charitable entity. As examples, the computing system may send a request to a card issuer or banking affiliate to transfer funds to the approved charitable entity. Additionally or alternatively, the computing system may send a request to a donor account (e.g., of the consumer donor and/or of the matching entity) to transfer funds to the approved charitable entity. In response to the request received at the source to transfer funds to the approved charitable entity, the source may authorize the transfer of funds and execute the same.

In block 135, based on the generated combined contribution data, a statement with one or more itemized labels may be generated by the enabled computing system. For example:

Trigger Purchase: Wal-Mart® on 127 Oak Drive at 7:00 pm in the amount of $9.70 (Label: Transaction #UI-385-RRY)

### Consumer Donor Identification: Jane Doe (Label: JD-145-TYX)

Selected Charity Cause: Healthcare (Label: H-13)

Weight: 100%

### Matching Donor Entity Identification:

Name: Coca-Cola® (Label: CC-856-PHG)

Matching Rate: %100 for Healthcare (Label: H-13)

Pledge Cap: $300,000 ($258,000 remaining)

### Donee Entity Identification:

Name: V Foundation for Cancer (Label: VF-293-RQW)

Associated Charity Cause: Healthcare (Label: H-13)

Priority: $1 Million for cancer growth analytics machine ($679,000 unmet)

### Monetary Amount:

Donation Roundup Amount from Jane Doe: $0.30

Matched Amount from Coca-Cola®: $0.30

Total donated amount to V Foundation for Cancer: $0.60

In some embodiments, the combined contribution data may be shared over social networks. In some embodiments, the combined contribution data may also be analyzed and/or mined to demonstrate consumer trends, market pulses, and/or social movements.

In block 140, the generated statement may be provided to the consumer donor. For example, in some embodiments, the generated statement may be sent by the computing system to the consumer donor via email, SMS text messaging, Bluetooth®, etc., and may be viewable in a variety of user interfaces, both interactive and non-interactive.

FIG. 2 illustrates a block diagram of an example computing system 250 communicatively coupled to an example database 205 to perform a purchase roundup matched donation of combined contributions by a consumer donor and a matching entity donor. The computing system 250 and the database 205 may be arranged according to at least one embodiment of the present disclosure.

In some embodiments, the computing system 250 may be enabled to determine a combined contribution by a consumer donor and a matching entity using various information such as consumer donor information 208, matching entity information 218, and/or approved charitable entity information 234 as shown in FIG. 2. The combined contribution by a consumer donor and a matching entity may not be previously known or determinable, but instead may be identified through a sequence of decision events.

For example, the sequence may begin with a triggering event such as a trigger purchase 210, which may cause other information blocks to be pulled or analyzed by the computing system 250. The trigger purchase 210 may be part of the consumer donor information 208 and may be identified by the computing system 250 in a variety of ways. For example, a method of payment, name, address, email, phone number, or other identifying information associated with information on file for the consumer donor may enable the computing system 250 to associate a given purchase as the trigger purchase 210. Additionally or alternatively, a donation roundup amount 212, a selectable charity cause 214, and a selectable contribution weight 216 may be part of the consumer donor information 208.

In some embodiments, the donation roundup amount 212 may include information that may be pulled by the computing system 250. The donation roundup amount 212 may be identified as such by the computing system 250 via recognition of the trigger purchase 210 described above. For instance, in some embodiments, the computing system 250 may identify the donation roundup amount 212 via calculating the difference between the amount of the trigger purchase 210 and the next whole dollar amount (e.g., $12.00 [next whole dollar]−$11.28 [trigger purchase amount]=$0.72 [donation roundup amount 212].

In some embodiments, in order for the computing system 250 to determine which matching entity will match the donation roundup amount 212, the matching entity information 218 may be pulled by the computing system 250 for one or more of the matching entities. The matching entity 218 may include a pledge amount 220, a matched/donated amount 222, a remaining balance 224, a matching rate 226, and charity information 228 that includes an associated charity cause 230 and approved charitable entities 232. For example, to determine which matching entity will match the donation roundup amount 212, the remaining balance 224 may first be determined by subtracting the historical matched/donated amount 222 from a total pledge amount 220. Thus, in some embodiments, if the donation roundup amount 212 exceeds the remaining balance 224 for a given matching entity, the computing system 250 may deselect or pass over that matching entity. In some embodiments, the computing system 250 may identify an appropriate matching entity by determining the associated charity cause 230 of the matching entity is the same as the selectable charity cause 214 of the consumer donor.

In some embodiments, the selectable charity cause 214 may include which charity causes or categories that the consumer donor wishes to further advance. The computing system 250 may identify the selectable charity cause 214 by textual or numerical analysis of input provided by the consumer donor. The textual or numerical analysis may correspond to pre-determined abbreviations, coding, dictionary sources, internet search engines, etc. Additionally or alternatively, the computing system 250 may identify the selectable charity cause 214 advanced by the consumer donor via performing survey questions or algorithmic learning functions.

In some embodiments, information about the selectable charity cause 214 may be pulled in order for the computing system 250 to determine which matching entity and/or which approved charitable entity 232 will be selected to donate and receive, respectively. For example, if a given matching entity does not associate with the selectable charity cause 214 chosen by the consumer donor, the computing system 250 may deselect or pass over that matching entity. Additionally or alternatively, the approved charitable entity information 234 may be pulled in order for the computing system 250 to determine which matching entity and/or which approved charitable entity 232 will be selected to donate and receive, respectively. For example, any information may be pulled of the charitable entity information 234, including: an associated charity cause 236, a priority task 238, and/or a matching entity approval list 240.

In some embodiments, an approved charitable entity 232 for a given matching entity may not be selected by the computing system 250 if each of the selectable charity cause 214 (chosen by the consumer donor), the associated charity cause 230 of the matching entity, and the associated charity cause 236 of the approved charitable entity 232 do not all match. In these or other embodiments, all three entities may have the same listed charity cause, but the approved charitable entity 232 may not be approved by a particular matching entity, in which case one or both of the matching entity and the approved charitable entity 232 may be deselected or passed over by the computing system 250. Additionally or alternatively, all three entities may have the same listed charity cause, but the matching entity is not provided on the matching entity approval list 240, in which case one or both of the matching entity and the approved charitable entity 232 may be deselected or passed over by the computing system 250.

In some embodiments, the selectable contribution weight 216 may also help the computing system 250 determine which matching entity is selected. For example, where the consumer donor has provided information that a selectable contribution weight 216 satisfies some threshold value, for instance, above 59%, then the computing system 250 may select a matching entity with a relatively high matching rate 226, for example, 70% or higher to better comport with the preferences or ideals of the consumer donor. In other embodiments, the matching rate 226 may be irrelevant to being selected by the computing system 250; however, the selectable contribution weight 216 may have a direct correlation, in combination with at least the donation roundup amount 212, as to how much money is directed to a priority task 238 listed by an approved charitable entity 232. For example, the computing system 250 may pull a $0.50 roundup donation and a 50% contribution weight to the environment under a given consumer donor; a matching rate 226 of 100% for the environment cause and a remaining balance 224 in excess of $0.25 for a given matching entity; and a priority task 238 requiring at least $0.50 or more as listed by an approved charitable entity. In this manner, the computing system 250 may pull various information blocks to determine a total amount to be donated to a charitable entity, which charitable entity is to be a donee, which matching entity will match the donation roundup amount 212, and in what respective proportions the total donation will be made of.

Specifically, the computing system 250 may determine a total donation amount or a combined contribution amount to an approved charitable entity 232 by executing various functions where the identified inputs may include those listed in the database of FIG. 2. For example, one function may be as follows: (Donation Roundup Amount 212+(Donation Roundup Amount 212×Matching Rate 226))×Selectable Contribution Weight 216=Total Donation. The computing system 250 may then cause the dispersal of the total donation amount. In some embodiments, the computing system 250 may cause the dispersal of a single lump sum (e.g., the total donation amount) to be dispersed to the approved charitable entity 232. In other embodiments, the computing system 250 may cause the dispersal of multiple portions of the total donation to the approved charitable entity 232. The multiple portions of the total donation may be caused to be dispersed simultaneously or at different times. For example, in the event that multiple portions of the total donation come from different banking institutions, the dispersal of the multiple portions may occur at different times. Additionally or alternatively, the donation roundup amount 212 from the consumer donor may occur at a first instance, and the matched/donated amount 222 may occur at a second instance different from the first instance.

In some embodiments, the computing system 250 may provide to the consumer donor and/or the matching entity one or more of the total donation amount, and/or separate entries detailing the donation roundup amount 212 from the consumer donor and the matched/donated amount 222 from the matching entity. Specifically, the computing system 250 may provide the foregoing via email, SMS text messaging, Bluetooth®, etc., and may be viewable in a variety of user interfaces, both interactive and non-interactive.

One skilled in the art will appreciate that, for these processes, operations, and methods, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

As indicated above, the embodiments described herein may include the use of a special purpose or general purpose computer (e.g., a processor element) including various computer hardware or software modules. Further, as indicated above, embodiments described herein may be implemented using computer-readable media (e.g., a memory element) for carrying or having computer-executable instructions or data structures stored thereon.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method comprising:
receiving consumer donor information about a consumer donor including a trigger purchase, a donation roundup amount, a selectable charity cause for receiving at least a portion of the donation roundup amount, and a selectable contribution weight of the donation roundup amount corresponding to the charity cause;
receiving matching entity information including a pledge amount and at least one associated charity cause;
receiving approved charitable entity information including at least one associated charity cause and at least one priority requiring monetary funds for advancement;
determining a matching donor entity and a donee entity based on one or more of the received consumer donor information, the received matching entity information, and the received approved charitable entity information;
in response to the determining, generating combined contribution data including:
a consumer donor identification label;
a matching donor entity identification label;
a donee entity identification label;
a monetary amount label including a separate amount for both of the donation round-up amount from the consumer donor and a matched amount from the matching donor entity;
an associated charity cause label; and
a trigger purchase label identifying the trigger purchase;
based on the generated combined contribution data, identifying a total monetary value to send to the donee entity;
based on the generated combined contribution data, generating a statement with one or more labels itemized; and
providing the generated statement to the consumer donor.
